(19) United States
(12) Patent Application Publication
(10) Pub. No.: US 2024/0384550 A1
(43) Pub. Date: Nov. 21, 2024

(54) PREFABRICATED POOL

(71) Applicant: PLUNGIE IP PTY LTD, Brisbane, Queensland (AU)

(72) Inventor: Benjamin PETERSEN, Deception Bay, Queensland (AU)

(21) Appl. No.: 18/576,600

(22) PCT Filed: Jul. 6, 2022
(86) PCT No.: PCT/AU2022/050703

§ 371 Date: Jan. 4, 2024

(30) Foreign Application Priority Data
Jul. 6, 2021 (AU) 2021204732

(51) Int. Cl. E04H 4/00; E04H 4/14

(52) U.S. Cl. CPC E04H 4/0037; E04H 4/14

(57) ABSTRACT

A prefabricated pool comprising: a pool shell having one or more sidewalls; the pool shell being formed from a settable material wherein the one or more sidewalls include one or more inserts, the one or more inserts being physically held in position by the set settable material.

### FIELD OF THE INVENTION

This invention relates to a prefabricated pool. In particular, the invention relates to pools that are manufactured offsite prior to installation.

### BACKGROUND OF THE INVENTION

Smaller pools, often referred to as plunge pools, have become very popular in recent years. A factor that has driven the popularity of smaller pools is that recently smaller pools have been able to be manufactured offsite and delivered virtually complete. This reduces the installation time of the pool to a small number of days. International publication no. WO/2019/157564 describes such a pool. The pool described in WO/2019/157564 has been developed through significant research and development to provide a pool that is both structurally sound yet sufficiently light to conduct transportation and installation at a commercially viable cost.

An issue with producing a pool, such as that described in WO/2019/157564, is that many of the traditional techniques relied on for producing structural elements adjacent traditional inground pools, which are built on-site, cannot be utilised.

International publication No. WO/2019/157564 by the Applicant is hereby incorporated by reference to this patent application.

### OBJECT OF THE INVENTION

It is an object of the invention to overcome and/or alleviate the abovementioned problems and/or provide the consumer with a useful or commercial choice.

### SUMMARY OF THE INVENTION

In one form, although it need not be the only or indeed the broadest form, there is provided a prefabricated pool comprising:
a pool shell having one or more sidewalls;
the pool shell being formed from a settable material
wherein the one or more sidewalls include one or more inserts, the one or more inserts being physically held in position by the set settable material.

The inserts may have an attachment portion and a locking portion. The attachment portion may be in the form of a hole that is internally threaded. The hole may be a blind hole.

The locking portion may prevent rotation of the insert about a longitudinal axis of the insert with respect to the sidewall. The locking portion may include one or more apertures and/or projections that engage with the hardened or cured settable material. The locking portion may also assist in preventing the removal of the insert from the sidewall by engagement of the locking portion with the hardened or cured settable material. That is, the hardened or cured settable material may solely prevent the removal of an insert.

Typically there are a plurality of inserts. The inserts may be located adjacent a top of the sidewalls. Normally the inserts are located within 300 mm of the top of a sidewall. More preferably the inserts are located within 200 mm of the top of a sidewall. Most preferably, the inserts are located within 150 mm of the top of a sidewall.

Two or more inserts may be vertically aligned with each other. Typically two inserts are vertically aligned with each other. Normally two vertically aligned inserts may be less than 200 mm apart. Preferably, the two vertically aligned inserts are between 75 mm and 150 mm apart. More preferably, the two vertically inserts are approximately 100 mm apart.

Typically, the first vertically aligned insert is between 25 mm and 125 mm from the top of a sidewall, and the second vertically aligned insert is between 125 mm and 300 mm from the top of the sidewall. Preferably the first vertically aligned insert is between 35 mm and 85 mm from the top of a sidewall, and the second vertically aligned insert is between 135 mm and 200 mm from the top of the sidewall. Most preferably, the first vertically aligned insert is approximately 50 mm from the top of a sidewall and the second vertically aligned insert is approximately 150 mm from the top of the sidewall.

A length of one or more inserts may be less than half the wall thickness. Typically, the length of the inserts is less than 45 mm.

Typically, there are at least four inserts located on each sidewall. Preferably there are at least eight inserts located on each sidewall.

Normally there are at least two sets of two vertically aligned inserts on each sidewall. Preferably there are at least four sets of vertically aligned inserts on each sidewall.

Normally the settable material is a cementitious material. Preferably, the cementitious material is concrete. The cementitious material may comprise cement alternatives (whilst still being of the nature of cement). For example, cementitious material may comprise a geopolymer binder. The geopolymer binder may result from a chemical activation of fly ash and slag.

Preferably, one or more reinforcing elements are located within the pool shell. The reinforcing elements may comprise fibre reinforcement, preferably comprising plastic fibres. Preferably, the reinforcing elements are reinforcing rods. Preferably, the reinforcing rods are arranged in a mesh configuration. Preferably the reinforcing rods form a reinforcement cage. The reinforcing rods may be made of steel. Alternatively, the reinforcing rods may be made of composite materials.

The inserts may be located within the sidewall between the reinforcement elements.

Preferably, one or more lifting members are located within at least one of the floor, sidewalls and peripheral wall. More preferably, the lifting members comprise ferrules or lugs. The ferrules may be threaded. The lugs maybe solid. Preferably the lifting members are mounted to, (affixed or fixed) the reinforcing elements.

Preferably, sidewalls have a thickness of between approximately 80 mm to 120 mm. More preferably, a thickness of between approximately 85 mm to 110 mm. Even more preferably, a thickness of approximately 90 mm. Preferably the sidewalls have a substantially constant thickness throughout their length and height. Preferably a peripheral edge of a substantially planar sidewall is substantially the same thickness as the sidewall itself.

Preferably, one or more of the sidewalls includes an aperture. Preferably the aperture is a cut-out section of the sidewall. Preferably the cut-out section is configured to receive a skimmer box.

The pool shell may include a floor. The sidewalls may be connected to the floor. Normally there are four sidewalls.

The pool shell may include an open-top. The area of the open-top may be larger than the area of the floor.

The pool shell may define an internal swimming hollow. The pool shell may include one or more steps that form part of the internal swimming hollow. An external cavity may be formed under the one or more steps. The one or more steps may extend substantially perpendicularly from the one or more sidewalls.

The floor may stop adjacent the end of the one or more steps. One or more of the sidewalls located adjacent the one or more steps step may extend past an end of the one or more steps to define the external cavity. Typically there are two sidewalls that extend past an end of a step to define the cavity. The two side walls may define a perimeter of the cavity.

The swimming hollow may include an internal surface that is waterproofed. Preferably the internal surface is covered by a coating. The coating may be tiles, paint or polymer. Preferably the internal surface is treated with a spray-on thermo-polymer such as, for example, EcoFinish™

Preferably the joins between one or more adjacent sidewalls are reinforced. Preferably the joins are reinforced with a chamfered or angled portion.

Preferably the floor and sidewalls have substantially the same thickness. The floor and sidewalls may be integrally formed.

One more fence posts, fence panels and/or fence brackets may be attached to the sidewalls via the one or more inserts. Typically, at least two vertically aligned inserts are used to attach a single fence, fence panel and/or fence brackets to a sidewall.

One or more starter bars or reinforcement bars may be attached to one or more sidewalls via one or more inserts.

In one form, although not necessarily the only form, the invention resides in a cover for a pool, the cover comprising:
a plurality of panels joined together; and
a skirt attached to the panels, the shirt extending downwardly from the panels;
wherein the skirt includes a plurality of attachment holes.

The cover may be attached to the sidewalls of a pool via one or more inserts located within the sidewall.

Each panel may be a composite panel. The composite panel may be a sandwich panel having a skin located on each side of the panel that sandwiches a filling. The filling may be an insulated foam (such as expanded polystyrene) or polyisocyanurate or mineral wool. The skin may be made from metal. The metal may be steel.

Each panel may include a tongue that extends along one side and a groove that extends along another side. The plurality of panels may be joined together using a tongue from one panel that interconnects a groove from another panel.

The skirt may be reinforced using one or more brackets. Typically the brackets are L-shaped brackets. The brackets may be connected to a panel and/or skirt. Typically there are two brackets located on each side of the plurality of panels.

In another form, the invention resides in a method of producing a prefabricated pool, the method comprising the steps of:
locating one or more inserts within a mould, the locating of the inserts in the mould being where the sidewalls are formed;
pouring a settable material into the mould so that the settable material partially surrounds the inserts;
allowing the settable material to set, thereby causing the settable material to physically hold in position the one or more inserts.

The method may further include the step of attaching the insert onto a locating tool. The locating tool may be attached to an attachment portion of the insert. The locating tool may include a male threaded shaft. The attachment portion may include a female threaded hole. The male threaded hole may be located within the female threaded so that the insert can be located through the mould holes located in the mould.

The method may further include the step of locating reinforcement elements in the mould. The reinforcement elements are typically in the form of a reinforcement cage.

The method may include the further step of removing a pool shell from the mould.

The method may include the further step of applying an internal surface to a swimming hollow of the pool shell. Preferably the step of finishing the internal surface of the plunge pool comprises treating the surface with a thermo-polymer.

The method may include the step of attaching a cover to the pool shell using the inserts located within the sidewalls of the pool shell.

The method may comprise the further step of transporting the pool shell too and installing the pool shell at a desired location away from where the pool shell was moulded.

The method may comprise the further step of attaching one or more fence posts, fence panels and/or fence brackets to the sidewalls of the pool shell via the one or more inserts. Typically, at least two vertically aligned inserts are used to attach a single fence, fence panel and/or fence brackets to a sidewall.

The method may comprise the further step of attaching one or more starter bars or reinforcement bars to the sidewalls of the pool shell via one or more inserts.

Further features and advantages of the present invention will become apparent from the following detailed description.

### BRIEF DESCRIPTION OF THE DRAWINGS

Embodiments of the invention will be described, by way of example only, with reference to the accompanying figures in which:

FIG. 1A is a top view of a prefabricated pool according to a first embodiment of the invention;

FIG. 1B is a perspective view of a prefabricated pool according to FIG. 1A;

FIG. 1C is a side sectional view of a prefabricated pool according to FIG. 1A;

FIG. 2A is a front view of an insert for a prefabricated pool according to a first embodiment;

FIG. 2B is a side sectional view of an insert for a prefabricated pool according to FIG. 2A;

FIG. 2C is a top view of an insert for a prefabricated pool according to FIG. 2A;

FIG. 2D is a perspective view of an insert for a prefabricated pool according to FIG. 2A;

FIG. 3A is a front view of an insert for a prefabricated pool according to a second embodiment;

FIG. 3B is a side sectional view of an insert for a prefabricated pool according to FIG. 3A;

FIG. 3C is a top view of an insert for a prefabricated pool according to FIG. 3A;

FIG. 3D is a perspective view of an insert for a prefabricated pool according to FIG. 3A;

FIG. 4A is a front view of an insert for a prefabricated pool according to a third embodiment;

FIG. 4B is a side sectional view of an insert for a prefabricated pool according to FIG. 4A;

FIG. 4C is a top view of an insert for a prefabricated pool according to FIG. 4A;

FIG. 4D is a perspective view of an insert for a prefabricated pool according to FIG. 4A;

FIG. 5A is a front view of an insert for a prefabricated pool according to a fourth embodiment;

FIG. 5B is a side sectional view of an insert for a prefabricated pool according to FIG. 5A;

FIG. 5C is a top view of an insert for a prefabricated pool according to FIG. 5A;

FIG. 5D is a perspective view of an insert for a prefabricated pool according to FIG. 5A;

FIG. 6A is a perspective view of a cover attached to a prefabricated pool according to a first embodiment;

FIG. 6B an exploded perspective view of a cover attached to a prefabricated pool according to FIG. 6A;

FIG. 6C a top view of a cover attached to a prefabricated pool according to FIG. 6A;

FIG. 6D a side sectional view of a cover attached to a prefabricated pool according to FIG. 6A;

FIG. 6E a detailed side sectional view of a cover attached to a prefabricated pool according to FIG. 6D;

FIG. 7A is a perspective view of a series of fence panels attached to a prefabricated pool according to a first embodiment;

FIG. 7B an exploded perspective view of a series of fence panels attached to a prefabricated pool according to FIG. 7A;

FIG. 8A is a perspective view of a reinforcement cage attached to a prefabricated pool according to a first embodiment;

FIG. 8B an exploded perspective view of a reinforcement cage attached to a prefabricated pool according to FIG. 8A;

FIG. 8C a detailed perspective view of a reinforcement cage attached to a prefabricated pool according to FIG. 8B;

FIG. 9A is a perspective view of a mould for a prefabricated pool according to a first embodiment;

FIG. 9B an exploded perspective view of a mould for a prefabricated pool according to FIG. 9A;

FIG. 9C a detailed perspective view of a mould for a prefabricated pool according to FIG. 9B;

FIG. 10A is a perspective view of a tool used to locate inserts for a prefabricated pool according to a first embodiment;

FIG. 10B an exploded perspective view of a tool used to locate inserts for a prefabricated pool according to FIG. 9A;

FIG. 11 is an exploded perspective view of the process to produce a prefabricated pool according to a first embodiment;

FIG. 12A is a side view of a prefabricated pool according to a second embodiment of the invention; and

FIG. 12B is a side sectional view of a prefabricated pool according to FIG. 12A;

### DETAILED DESCRIPTION OF THE PREFERRED EMBODIMENTS

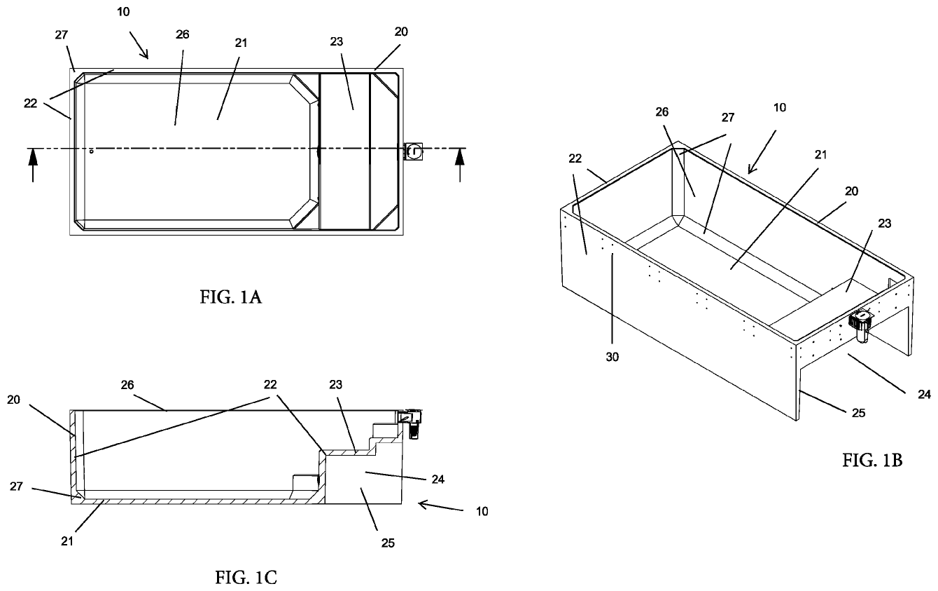

FIG. 1A to 1C shows a prefabricated pool 10 that is manufactured in a factory. The prefabricated pool 10 can be kept in stock, allowing a pool 10 to be delivered and installed in a matter of days from receiving an order from a customer.

The prefabricated pool 10 is made from steel-reinforced concrete. The prefabricated pool 10 is formed from a pool shell 20 having a floor 21 connected to four sidewalls 22. The floor 21 and the sidewalls 22 are integrally formed. A set of stairs 23 is formed from one of the sidewalls 22. This creates an external cavity 24 located under the stairs 23. The two sidewalls 22 located on either side of the stairs 23 extend past the stairs 23 to form wings 25 and define the end of the cavity 24. The way the stairs 23 are formed using the cavity 24 reduces the weight of the pool 10.

The pool 10 has an open-top 26 that is substantially rectangular in shape. The floor 21 of the pool 10 is also rectangular in shape. However, the area of the open-top 26 is larger than the floor 21. This is due to the floor 21 stopping adjacent the sidewall 22 in which the stairs 23 are formed. The sidewalls 22 that extend past the stairs 23 provide stability that is desired by the pool shell 20 when it is placed on a ground surface.

The thickness of the floor 21 and sidewalls 22 all have the same wall thickness, namely 90 mm. Chamfered joins 27 join adjacent sidewalls 22 and where the sidewalls 22 join the floor 21.

A series of inserts 30 extend around and are located within the four sidewalls 22 of the pool shell 20. The inserts 30 are positioned in two rows. The first row of inserts is located approximately 50 mm from the top of their respective sidewall 22. The second row of inserts 30 is located approximately 150 mm from the top of their respective sidewall 22. Each insert 30 is vertically aligned with another adjacent insert 30.

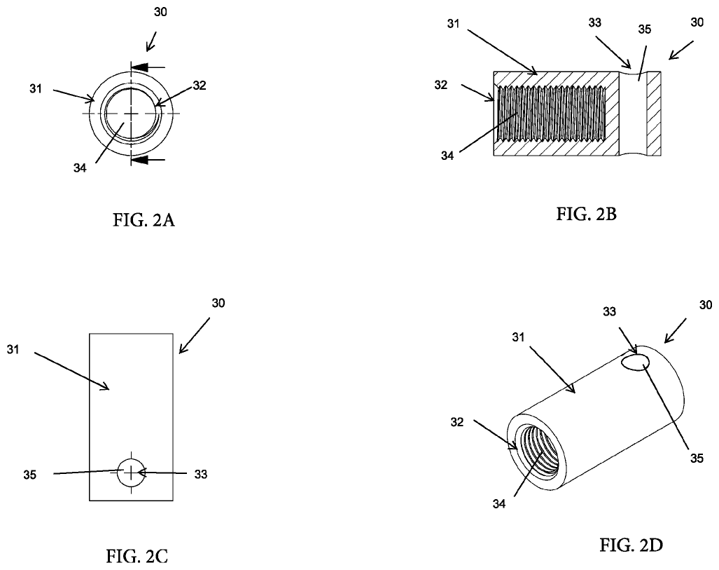

The inserts 30, show in more detail in FIGS. 2A to 2D, are formed from a body 31 that has an attachment portion 32 and a locking portion 33. The body 31 is cylindrical in shape and approximately 40 mm in length. The attachment portion 32 is in the form blind hole 34 that is internally threaded. The locking portion 33 is in the form of a locking hole 35 that extends through the body 31. The insert 30 is located within the sidewall 22 so that the attachment portion 32 (i.e. the blind threaded hole 34) can be accessed from the sidewall 34. The remainder of the body 31 is encased in hardened concrete. That is, hardened concrete is located through the locking hole 34. The set concrete prevents the removal of the insert 30 from the sidewall 22. It also prevents rotational movement of the insert 30 within the sidewall 22.

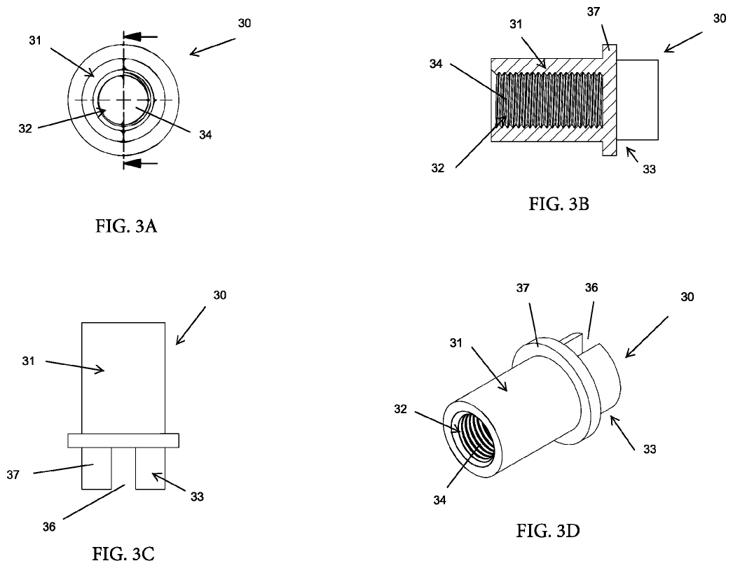

FIGS. 3A to 3D show a further embodiment of an insert 30. The attachment portion 32 is the same as the attachment portion 32 shown in FIGS. 2A to 2D. However, the locking portion 33 has changed. In this embodiment, the locking portion 33 is formed from a rectangular slot 36 located at one end of the body 31 and a collar 37 located around the body 31. The rectangular slot 36 prevents rotational movement of the insert 30 with respect to the sidewall 22, whilst the collar 37 prevents the removal of the insert 30 from the sidewall 22.

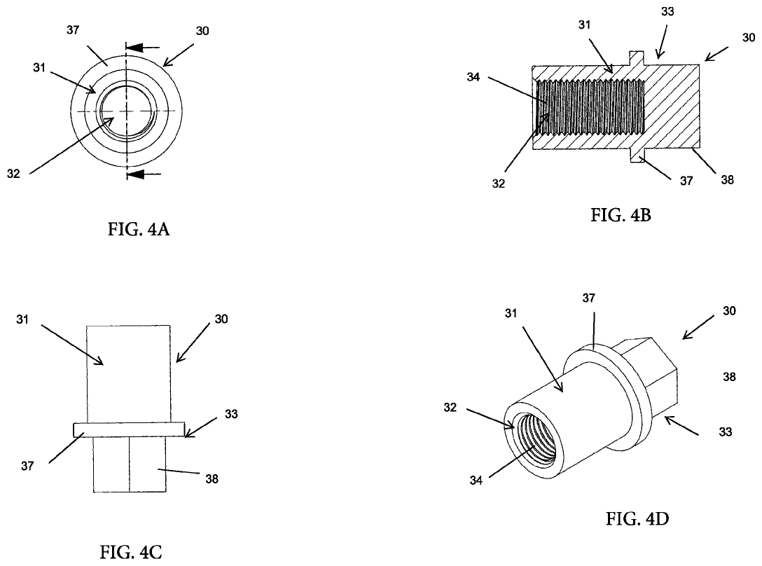

FIGS. 4A to 4D show a further embodiment of an insert 30. The attachment portion 32 is the same as the attachment portion 32 shown in FIGS. 2A to 2D. However, the locking portion 33 has changed. In this embodiment, the locking portion 33 is formed from a hexagonal section 38 located at one end of the body 31 and a collar 37 located around the body 31. The hexagonal section 38 prevents rotational movement of the insert 30 with respect to the sidewall 22, whilst the collar 37 prevents removal of the insert 30 from the sidewall 22.

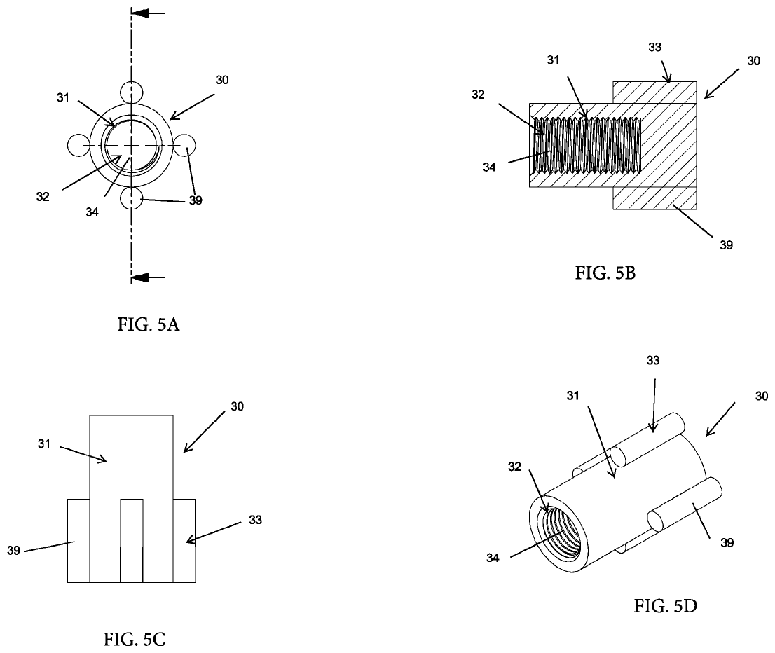

FIGS. 5A to 5D show a further embodiment of an insert 30. The attachment portion 32 is the same as the attachment portion 32 shown in FIGS. 2A and 2D. However, the locking portion has changed 33. In this embodiment, the locking portion 33 is formed from a series of splines 39 that extend longitudinally along the body 31 located at one end of the body 31. The splines 31 prevent rotational movement of the insert 30 with respect to the sidewall 22 and prevent the insert 30 from being removed from the sidewall 22.

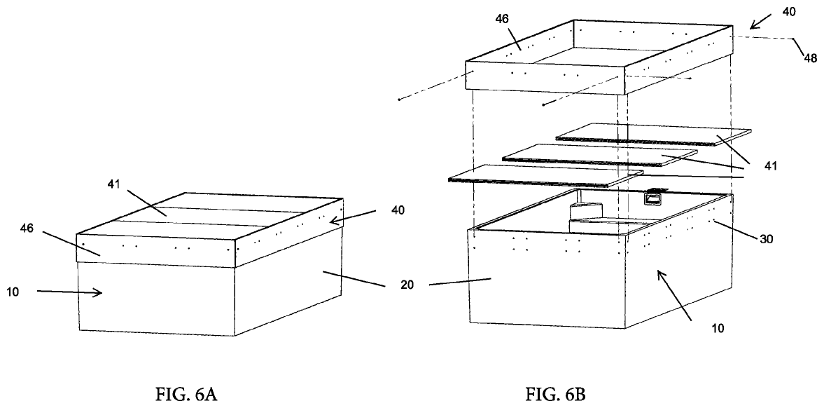

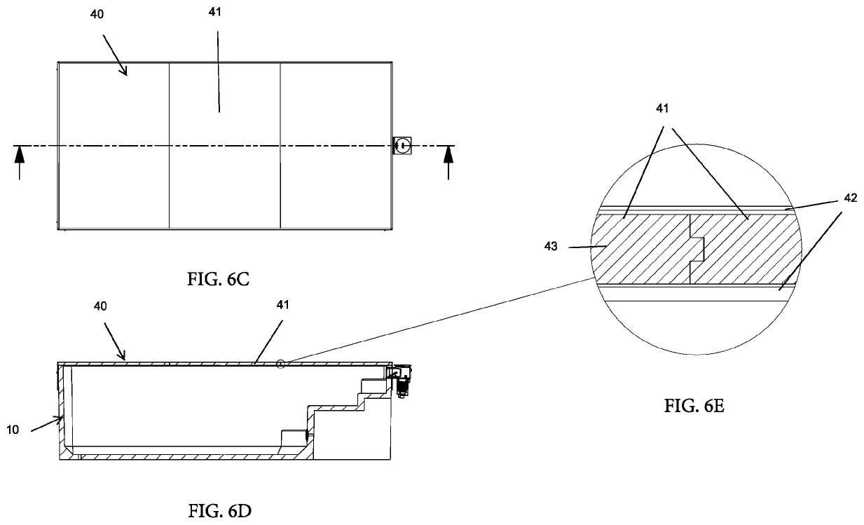

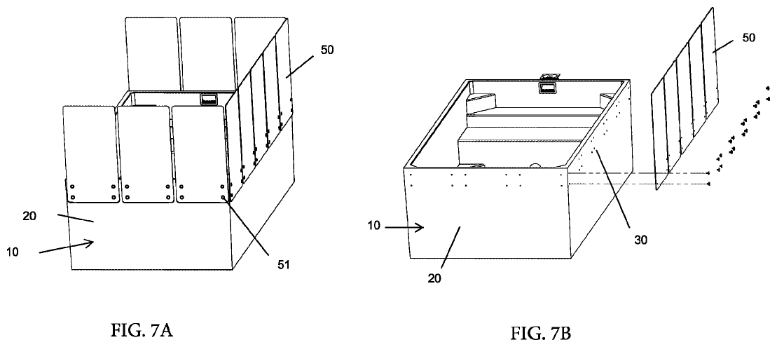

The inserts 30 can be used to mount a variety of different structures such as a cover, fence posts, fence, panels, fence brackets, starter bars and reinforcement bars. FIGS. 6A to 6E show how a cover 40 is mounted to the top of the pool shell 20 using the inserts 30. The cover 40 provides protection to the interior of the pool shell 20 as well as providing protection from people falling into the empty pool shell 20 whilst the pool 10 is installed.

The cover 40 is formed from three composite sandwich panels 41. Each sandwich panel 41 includes a metal skin 42, and a core 43 made from an expanded polystyrene product with a flame retardant. Each panel 41 has a tongue 44 mounted on one side of the panel 41 and a groove 45 located on the opposite side of the panel 41. The tongue 44 of one panel 41 and the groove 45 of an adjacent panel 41 is used to interlock adjacent panels 41 together. Additional fasteners can also used to lock the panels 41 together.

A skirt 46 is located around the perimeter of the connected panels 41. The skirt 45 is made from metal and connected to the panels 41 using appropriate fasteners. It would be appreciated that the thickness of the metal may be varied depending on its use. Further, it would be appreciated that areas of the skirt 45 may be reinforced with brackets as is required.

The cover 40 is connected to the pool shell 20 via the inserts 30. To attach the cover 40 to the pool shell 20, the cover 40 is located over the open-top 26 and sidewalls 22 of the pool shell 20. The panels 41 extend between the top of the sidewalls 22, and the skirt 46 extends over the sides of the sidewalls 22. Fastening holes 47 located through the skirt 46 (and brackets if required) allow bolts (not shown) to be passed through the skirt 46 (and brackets if required) into the blind threaded holes 34 of the respective inserts 30. The bolts are tightened to hold the cover 40 fast to the pool shell 20. The pool 10 can be transported and installed in this manner. The cover 40 can be unbolted from the pool shell and reused when the pool is installed or left on as a safety measure to prevent a person from falling into the pool 10 during construction of an adjacent house.

FIG. 7A to 7B show the inserts 30 being used to mount glass fencing panels 50 to the sidewalls 22 of the pool shell 20. The glass fencing panels 50 have mounting holes 51 that extend through them and are spaced at the same spacing as the respective inserts 30. To mount the fencing panels 50, bolts are located through the mounting holes 51 and into the blind thread holes 34 of the inserts 30.

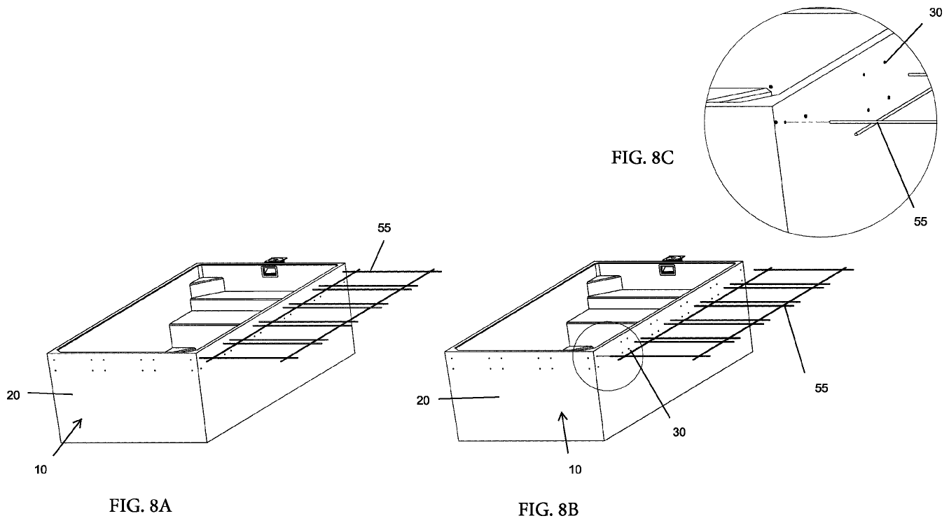

FIGS. 8A to 8C show the inserts 30 being used to attach reinforcement bars 55 to the pool shell 20. The reinforcement bars 55 are typically used in the formation of an adjacent slab (not shown), and joining the reinforcement bars 55 to the inserts 30 assists in preventing subsidence. The reinforcement bars 55 are screwed directly into respective blind threaded holes 34 in the inserts 30.

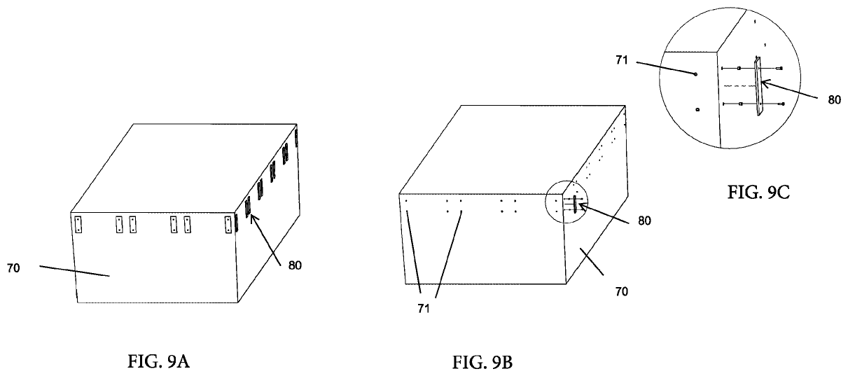

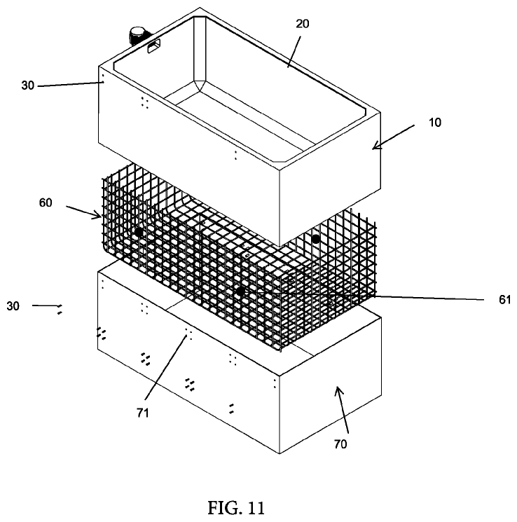

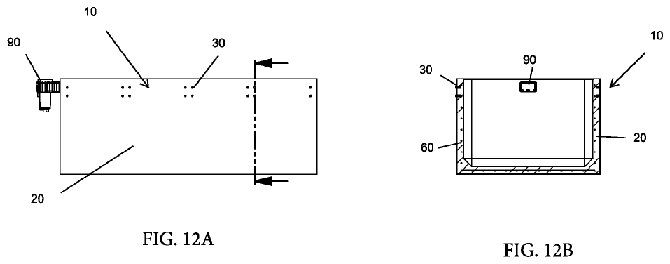

To manufacture a prefabricated pool 10, a mould 70 is used, as shown in FIG. 9A to 9C. The prefabricated pool 10 that is shown in describing the use of the mould 70, shown in FIGS. 11, 12A and 12B, is slightly different to the prefabricated pool 10 shown in FIG. 1A to 1C. The pool shown in FIGS. 11, 12A and 12B does not have stairs 23. However, it would be appreciated by a person skilled in the art that the only difference in the process used to create this prefabricated pool 10 is the shape of the mould 70.

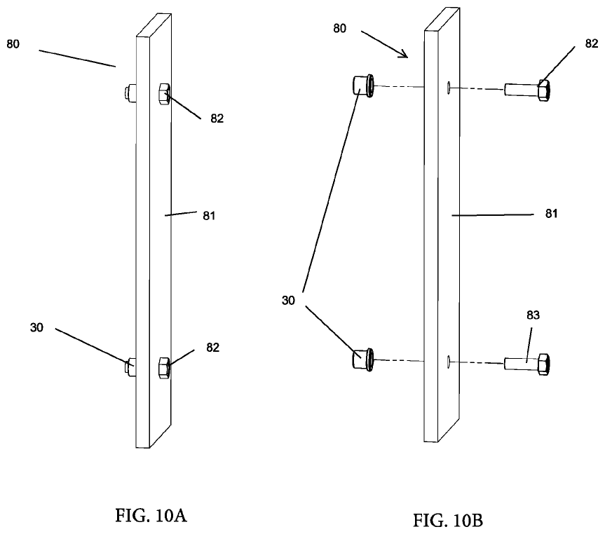

The first step in producing a pool shell 20 is to locate a steel reinforcement cage 60, as shown in FIG. 11, within the mould 70. Two lifting members 61 are attached to each side of the cage 60. The next step is to locate all of the inserts 30 within the sides of the mould 70. A set of two vertically aligned inserts 30 are attached to a locating tool 80. The locating tool 80 is shown in more detail in FIGS. 10A and 10B. The locating 80 includes a locating plate 81 which is used to rotatably mount two bolts 82. Each bolt 82 has a threaded shaft 83. The inserts 30 are attached to the bolts 82 by screwing the threaded shaft 83 into the attachment portions 32 of the inserts 30. The side of the mould 70 has insert holes 71 located around the mould 70. All of the inserts 30 are located through the insert holes 71 in the mould 70. The inserts 30 are held in position within the mould 70 by their respective locating plates 81 of the locating tools 80. A central mould piece (not shown) is located in the middle of the reinforcement cage 60.

The next step is to pour concrete is poured into the mould 70 to surround both the inserts 30 and the reinforcement cage 60. The concrete passes over and surrounds the locking portion 33 of the inserts 30. The concrete is then allowed to set. The bolts 82 are then removed from inserts 30. The pool shell 30 can then be removed from the mould 70. The depth and location of the inserts 30 with respect to the reinforcement cage 60 is shown in FIGS. 12A and 12B specifically showing the inserts being located between gaps in the reinforcement cage 60. A lining may then be applied to a swimming hollow of the pool shell 20, such as tiles or a thermoplastic coating. Pool furniture such as a skimmer box 90 can also be added. The prefabricated pool 10 can then be delivered from the factory to the installation location and installed.

The inserts 30 located within the sidewalls 22 of the prefabricated pool 10 provide a large number of uses that save time and prevent the narrow sidewalls 22 from being damages from drilling.

In this specification, the terms “comprise”, “comprises”, “comprising” or similar terms are intended to mean a non-exclusive inclusion, such that a system, method or apparatus that comprises a list of elements does not include those elements solely but may well include other elements not listed.

In this specification, terms such as upward, downward, horizontal and vertical, and their grammatical derivatives, are used to describe the invention in its normal orientation and are not to be construed to limit the invention to any particular orientation.

The reference to any prior art in this specification is not, and should not be taken as, an acknowledgement or any form of suggestion that the prior art forms part of the common general knowledge.

It should be appreciated that various other changes and modifications may be made to the embodiments described without departing from the spirit or scope of the invention.

1. A prefabricated pool comprising:
a pool shell having one or more sidewalls;
the pool shell being formed from a settable material; and
wherein the one or more sidewalls include one or more inserts, the one or more inserts being physically held in position by the set settable material.

2. The prefabricated pool of claim 1, wherein there is a plurality of inserts.

3. The prefabricated pool of claim 2, wherein the inserts have an attachment portion and a locking portion.

4. The prefabricated pool of claim 3, wherein the attachment portion is in the form of a hole that is internally threaded.

5. The prefabricated pool of claim 3, wherein the locking portion prevents rotation of the insert about a longitudinal axis of the insert with respect to the sidewall.

6. The prefabricated pool of claim 3, wherein the locking portion includes one or more apertures or projections that engage with the hardened or cured settable material.

7-8. (canceled)

9. The prefabricated pool of claim 1, wherein a length of one or more inserts may be less than half the wall thickness.

9-10. (canceled)

11. The prefabricated pool of claim 1, wherein the inserts are located within the sidewall between reinforcement elements.

12. (canceled)

13. The prefabricated pool of claim 1, wherein a peripheral edge of a substantially planar sidewall is substantially the same thickness as the sidewall itself.

14. The prefabricated pool of claim 1, wherein the pool shell includes a floor, the sidewalls being connected to the floor.

15. (canceled)

16. The prefabricated pool of claim 1, wherein the pool shell may include one or more steps or seats that form part of the internal swimming hollow, and an external cavity is formed under the steps or seat.

17. The prefabricated pool of claim 16, wherein one or more of the sidewalls located adjacent a step or seat extend past an end of the step to define the external cavity.

18-19. (canceled)

20. The prefabricated pool of claim 1, wherein one more fence posts, fence panels and/or fence brackets are attached to the sidewalls via the one or more inserts.

21. The prefabricated pool of claim 1, wherein one or more starter bars or reinforcement bars are attached to one or more sidewalls via one or more inserts.

22. The prefabricated pool of claim 1, wherein a cover is attached to one or more sidewalls via one or more inserts.

23. A method of producing a prefabricated pool, comprising the steps of:
locating one or more inserts within a mould, the locating of the inserts in the mould being where the sidewalls are formed;
pouring a settable material into the mould so that the settable material partially surrounds the inserts; and
allowing the settable material to set, thereby causing the settable material to physically hold in position the one or more inserts.

24-27. (canceled)

28. The method of claim 23, further including the step of attaching a cover to the pool shell using the inserts located within the sidewalls of the pool shell.

29. The method of claim 23, further including the step of transporting the pool shell too and installing the pool shell at a desired location away from where the pool shell was moulded.

30. The method of claim 23, further including the step of attaching one or more fence posts, fence panels and/or fence brackets to the sidewalls of the pool shell via the one or more inserts.

31. The method of claim 23, further including the step of attaching one or more starter bars or reinforcement bars to the sidewalls of the pool shell via one or more inserts.
